(19) United States
(12) Patent Application Publication
(10) Pub. No.: US 2023/0216330 A1
(43) Pub. Date: Jul. 6, 2023

(54) SUPERCAPACITOR AND LEAD-ACID BATTERY HYBRID BATTERY WITH CHARGING CAPABILITY

(71) Applicant: SUSTAINABLE ENERGY TECHNOLOGIES, INC., Wilmington, DE (US)

(72) Inventor: John Cronin, Wilmington, DE (US)

(21) Appl. No.: 18/091,756

(22) Filed: Dec. 30, 2022

Related U.S. Application Data
(60) Provisional application No. 63/295,484, filed on Dec. 30, 2021.

(51) Int. Cl. H02J 7/34; H01M 10/44; H01M 10/48; H01M 10/42

(52) U.S. Cl. CPC H02J 7/345; H01M 10/44; H01M 10/48; H01M 10/425; H01M 2010/4271

(57) ABSTRACT

Disclosed herein are systems and method for charging and/or discharging a hybrid battery that includes a supercapacitor and a lead-acid battery. The system can include a pair of terminals operable to be selectively coupled to one of the at least one supercapacitor or at least one lead-acid battery, said pair of terminals operable to provide for discharging and charging of the selectively coupled at least one supercapacitor or at least one lead-acid battery. The system can include a controller that is configured to store energy in the at least one supercapacitor and at least one lead-acid battery. The controller can be configured to determine if a charge or discharge state is applied to the pair of terminals. The controller can be configured to switch between the at least one supercapacitor or at least one lead-acid battery based on the determined charge status.

### CROSS-REFERENCE TO RELATED APPLICATIONS

This application claims the benefit of U.S. Provisional Application No. 63/295,484, filed Dec. 30, 2021, titled “SUPERCAPACITOR AND LEAD-ACID BATTERY HYBRID BATTERY WITH CHARGING CAPABILITY,” the disclosure of which is incorporated herein by reference in its entirety.

### FIELD OF THE DISCLOSURE

The present disclosure is generally related to a hybrid battery including a supercapacitor and a lead-acid battery.

### BACKGROUND

Some vehicles, such as electric vehicles or hybrid vehicles, include energy storage units such as batteries to power components and subsystems of the vehicles. For instance, in some vehicles, power from the energy storage units is used to power propulsion mechanisms, such as motors and/or engines, that propel the vehicle. Such a vehicle's effective driving range can be limited by how much power can be provided by its energy storage units. A supercapacitor is a type of capacitor that can be used as an energy storage unit.

### SUMMARY

Disclosed herein are systems and method for charging and/or discharging a hybrid battery that includes a supercapacitor and a lead-acid battery. The system includes at least one supercapacitor and at least one lead-acid battery. The system can include a pair of terminals operable to be selectively coupled to one of the at least one supercapacitor or at least one lead-acid battery, said pair of terminals operable to provide for discharging and charging of the selectively coupled at least one supercapacitor or at least one lead-acid battery. The system can include a controller that is configured to store energy in the at least one supercapacitor and at least one lead-acid battery. The controller can be configured to determine if a charge or discharge state is applied to the pair of terminals. The controller can be configured to switch between the at least one supercapacitor or at least one lead-acid battery based on the determined charge status.

In an illustrative example, a system is disclosed for charging and/or discharging a hybrid battery that includes a supercapacitor and a lead-acid battery. The system comprises: at least one supercapacitor; at least one lead-acid battery; a pair of terminals operable to be selectively coupled to one of the at least one supercapacitor or at least one lead-acid battery, said pair of terminals operable to provide for discharging and charging of the selectively coupled at least one supercapacitor or at least one lead-acid battery; a controller that is configured to: store energy in the at least one supercapacitor and at least one lead-acid battery; determine if a charge or discharge state is applied to the pair of terminals; switch between the at least one supercapacitor or at least one lead-acid battery based on the determined charge status.

In another illustrative example, a method is disclosed for charging and/or discharging a hybrid battery that includes a supercapacitor and a lead-acid battery. The method comprises: storing energy in a hybrid battery, which includes at least one supercapacitor and at least one lead-acid battery; determining if a charge or discharge state is applied to a pair of terminals that are selectively coupled to the at least one supercapacitor and the at least one lead-acid battery; determining a charge status of the at least one supercapacitor and the at least one lead-acid battery; switching between the at least one supercapacitor and the at least one lead-acid battery based on the determined charge status.

### BRIEF DESCRIPTIONS OF THE DRAWINGS

The accompanying drawings illustrate various embodiments of systems, methods, and other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram illustrating an architecture of a hybrid battery system, according to some examples.

FIG. 2 is a flow diagram illustrating a process performed using a Base Module, according to some examples.

FIG. 3 is a flow diagram illustrating a process performed using a SC Controller, according to some examples.

FIG. 4 is a flow diagram illustrating a process performed using a Charger Module, according to some examples.

FIG. 5 is a flow diagram illustrating a process performed using a Lead-Acid Module, according to some examples.

FIG. 6 is a block diagram illustrating a switch controlled by a controller that toggles between a supercapacitor connected state and a lead-acid battery connected state, according to some examples.

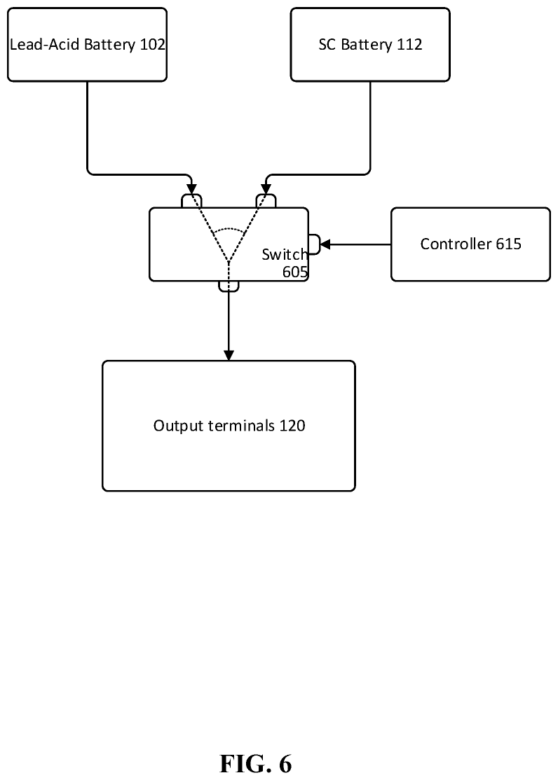

FIG. 7 is a block diagram illustrating use of one or more trained machine learning models of a machine learning engine to charge and/or discharge a hybrid battery, according to some examples.

FIG. 8 is a flow diagram illustrating a process for charging and/or discharging a hybrid battery using a control system, according to some examples.

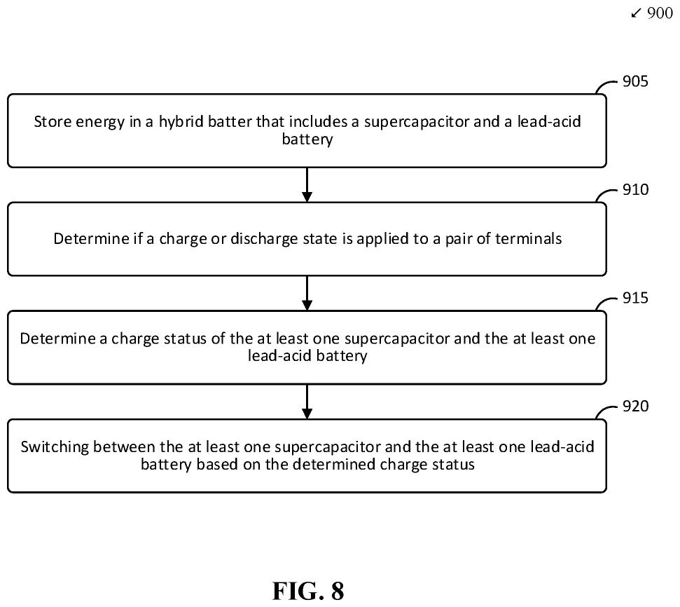

### DETAILED DESCRIPTION

Aspects of the present disclosure are disclosed in the following description and related figures directed to specific embodiments of the disclosure. Those of ordinary skill in the art will recognize that alternate embodiments may be devised without departing from the claims' spirit or scope. Additionally, well-known elements of exemplary embodiments of the disclosure will not be described in detail or will be omitted so as not to obscure the relevant details of the disclosure

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the disclosure, embodiments, or disclosure do not require that all embodiments include the discussed feature, advantage, or mode of operation.

Further, many of the embodiments described herein are described in sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present disclosure may be embodied in several different forms, all of which have been contemplated to be within the scope of the claimed subject matter. In addition, for each of the embodiments described herein, the corresponding form of any such embodiments may be described herein as, for example, a computer configured to perform the described action.

Disclosed herein are systems and method for charging and/or discharging a hybrid battery that includes a supercapacitor and a lead-acid battery. The system includes at least one supercapacitor and at least one lead-acid battery. The system can include a pair of terminals operable to be selectively coupled to one of the at least one supercapacitor or at least one lead-acid battery, said pair of terminals operable to provide for discharging and charging of the selectively coupled at least one supercapacitor or at least one lead-acid battery. The system can include a controller that is configured to store energy in the at least one supercapacitor and at least one lead-acid battery. The controller can be configured to determine if a charge or discharge state is applied to the pair of terminals. The controller can be configured to switch between the at least one supercapacitor or at least one lead-acid battery based on the determined charge status.

### Energy Storage Unit (ESU):

The ESU is a device that can store and deliver charge. It may comprise one or more power packs, which may comprise supercapacitors. The energy storage module may also comprise batteries, hybrid systems, fuel cells, etc. Capacitance provided in the components of the ESU may be in the form of electrostatic capacitance, pseudocapacitance, electrolytic capacitance, electronic double-layer capacitance, and electrochemical capacitance, and a combination thereof, such as both electrostatic double-layer capacitance and electrochemical pseudocapacitance, as may occur in supercapacitors. The ESU may be associated with or comprise control hardware and software with suitable sensors, as needed, for an energy control system (ECS) to manage any of the following: temperature control, discharging of the ESU whether collectively or of any of its components, charging of the ESU whether collectively or of any of its components, maintenance, interaction with batteries, battery emulation, communication with other devices, including devices that are directly connected, adjacent, or remotely such as by wireless communication, etc. In some aspects, the ESU may be portable and provided in a casing containing at least some components of the energy control system (ECS) and features such as communication systems, a display interface, etc.

The term supercapacitor as used herein can also refer to an ultracapacitor, which is an electrical component capable of holding hundreds of times more electrical charge quantity than a standard capacitor. This characteristic makes ultracapacitors useful in devices that require relatively little current and low voltage. In some situations, an ultracapacitor can take the place of a rechargeable low-voltage electrochemical battery. In some examples, the terms supercapacitor or ultracapacitor as used herein can also refer to other types of capacitors.

### Energy Control System (ECS)

The energy control system (ECS) combines hardware and software that manages various aspects of the ESU, including its energy to the device. The ECS regulates the energy storage unit (ESU) to control discharging, charging, and other features as desired, such as temperature, safety, efficiency, etc. The ESU may be adapted to give the ECS individual control over each power pack or optionally over each supercapacitor or grouped supercapacitor unit to tap the available power of individual supercapacitors efficiently and to properly charge individual supercapacitors rather than merely providing a single level of charge for the ESU as a whole that may be too little or too much for individual supercapacitors or their power packs.

The ECS may comprise or be operatively associated with a processor, a memory comprising code for the controller, a database, and communication tools such as a bus or wireless capabilities for interacting with an interface or other elements or otherwise providing information, information requests, or commands. The ECS may interact with individual power packs or supercapacitors through a crosspoint switch or other matrix systems. Further, the ECS may obtain information from individual power packs or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack or supercapacitor.

The ECS may comprise one or more modules that the processor can execute or govern according to code stored in a memory such as a chip, a hard drive, a cloud-based source, or another computer-readable medium.

The ECS may therefore manage any or all of the following: temperature control, discharging of the ESU whether collectively or of any of its components, charging of the ESU whether collectively or of any of its components, maintenance, interaction with batteries, or battery emulation, and communication with other devices, including devices that are directly connected, adjacent, or remotely such as by wireless communication.

The ECS may comprise one or more energy source modules that govern specific energy storage devices, such as a supercapacitor module for governing supercapacitors and a lithium module for governing lithium batteries. A lead-acid module for governing lead-acid batteries and a hybrid module for governing the combined cooperative use of a supercapacitor and a battery. Each of the energy storage modules may comprise software encoding algorithms for control such as for discharge or charging or managing individual energy sources, and may comprise or be operationally associated with hardware for redistributing charge among the energy sources to improve the efficiency of the ESU, for monitoring charge via charge measurement systems such as circuits for determining the charge state of the respective energy sources, etc., and may comprise or be operationally associated with devices for receiving and sending information to and from the ECS or its other modules, etc. The energy source modules may also cooperate with a charging module responsible for guiding the charging of the overall ESU to ensure a properly balanced charge and a discharge module that guides the efficient discharging of the ESU during use which may also seek to provide proper balance in the discharging of the energy sources.

The ECS may further comprise a dynamic module for managing changing requirements in power supplied. In some aspects, the dynamic module comprises anticipatory algorithms that seek to predict upcoming changes in power demand and adjust the state of the ECS to be ready to handle the change more effectively. For example, in one case, the ECS may communicate with a GPS and terrain map for the route being taken by the electric vehicle and recognize that a steep hill will soon be encountered. The ECS may anticipate the need to increase torque and thus the delivered electrical power from the ESU and thus activate additional power packs if only some are in use or otherwise increase the draw from the power packs to handle the change in slope efficiently to achieve desired objectives such as maintaining speed, reducing the need to shift gears on a hill, or reducing the risk of stalling or other problems.

The ECS may also comprise a communication module and an associated configuration system to properly configure the ECS to communicate with the interface or other aspects of the vehicle and communicate with central systems or other vehicles when desired. In such cases, a fleet of vehicles may be effectively monitored and managed to improve energy efficiency and track the performance of vehicles and their ESUs, thereby providing information that may assist with maintenance protocols. Such communication may occur wirelessly or through the cloud via a network interface, share information with various central databases, or access information from databases to assist with the vehicle's operation and the optimization of the ESU, for which historical data may be available in a database.

Databases of use with the ECS include databases on the charge and discharge behavior of the energy sources in the ESU to optimize both charging and discharging in use based on known characteristics, databases of topographical and other information for a route to be taken by the electric vehicle or an operation to be performed by another device employing the ESU, wherein the database provides guidance on what power demands are to be expected in advance to support anticipatory power management wherein the status of energy sources. The available charge is prepared in time to deliver the needed power proactively. Charging databases may also help describe the characteristics of an external power source used to charge the ESU. The external charge characteristics can prepare for impedance matching or other measures needed to handle a new input source to charge the ESU. With that data, the external power can be received with reduced losses and reduced risk of damaging elements in the ESU by overcharge, an excessive ripple in the current, etc.

Beyond relying on static information in databases, in some aspects, the controller is adapted to perform machine learning and to learn from situations faced constantly. In related aspects, the processor and the associated software form a “smart” controller based on machine learning or artificial intelligence adapted to handle a wide range of input and a wide range of operational demands.

### ESU Hardware

### Charging and Discharging Hardware

The charging and discharging hardware comprises the wiring, switches, charge detection circuits, current detection circuits, and other devices for proper control of charge applied to the power packs or the batteries or other energy storage units and temperature-control devices such as active cooling equipment and other safety devices. Active cooling devices (not shown) may include fans, circulating heat transfer fluids that pass through tubing or, in some cases, surround or immerse the power packs, thermoelectric cooling such as Peltier effect coolers, etc.

To charge and discharge an individual unit among the power packs to optimize the overall efficiency of the ESU, methods are needed to select one or more of many units from what may be a three-dimensional or two-dimensional array of connectors to the individual units. Any suitable methods and devices may be used for such operations, including crosspoint switches or other matrix switching tools. Crosspoint switches and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. SPST (Single-Pole Single-Throw) relays, for example, may be used. By applying a charge to individual supercapacitors within power packs or to individual power packs within the ESU, a charge can be applied directly to where it is needed, and a supercapacitor or power pack can be charged to an optimum level independently of other power packs or supercapacitors.

### Configuration Hardware

The configuration hardware comprises the switches, wiring, and other devices to transform the electrical configuration of the power packs between series and parallel configurations, such as that a matrix of power packs may be configured to be in series, in parallel, or some combination thereof. For example, a 12×6 array of power packs may have four groups in series, with each group having 3×6 power packs in parallel. A command can modify the configuration from the configuration module, which then causes the configuration hardware to make the change at an appropriate time (e.g., when the device is not in use).

### Sensors

The sensors may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs or batteries or other energy storage units or other characteristics of the ESU or the device as described more fully hereafter. The sensors may comprise sensors physically contained in or on the ESU or sensors mounted elsewhere, such as engine gauges in electronic communication with the ECS or its associated ESC.

### Batteries and Other Energy Sources

The ESU may be capable of charging or supplementing the power provided from the batteries or other energy storage units, including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox flow batteries, supercapacitor batteries, and combinations or hybrids thereof.

### Power Input/Output Interface

The ESU also comprises or is associated with a power input/output interface 152 that can receive charge from a device (or a plurality of devices in some cases) such as the grid or regenerative power sources in an electric vehicle (not shown) and can deliver charge to a device such as an electric vehicle (not shown). The power input/output interface may comprise one or more inverters, charge converters, or other circuits and devices to convert the current to the proper type (e.g., AC or DC) and voltage or amperage for either supplying power to or receiving power from the device it is connected to. Bidirectional DC-DC converters may also be applied.

The power input/output interface may be adapted to receive power from various power sources, such as via two-phase or three-phase power, DC power, etc. It may receive or provide power by wires, inductively, or other proper means. Converters, transformers, rectifiers, and the like may be employed as needed. The power received may be relatively steady from the grid or other sources at voltages such as 110V, 120V, 220V, 240V, etc., or from highly variable sources such as solar or wind power amperage or voltage vary. DC sources may be, by way of example, from 1V to 0V or higher, such as from 4V to 200V, 5V to 120V, 6V to V, 2V to 50V, 3V to 24V, or nominal voltages of about 4, 6, 12, 18, 24, 30, or 48 V. Similar ranges may apply to AC sources, but also including from 60V to 300V, from 90V to 250V, from V to 240 V, etc., operating at any proper frequency such as 50 Hz, 60 Hz, etc.

Power received or delivered may be modulated, converted, smoothed, rectified, or transformed in any useful way to better meet the application's needs and the requirements of the device and the ESU. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient power transfer.

The power input/out interface may have a plurality of receptacles of receiving power and a plurality of outlets for providing power to one or more devices. Conventional AC outlets may include any known outlet standard in North America, various parts of Europe, China, Hong Kong, etc.

### Energy Control System (ECS)

The energy storage unit (ESU) is governed or controlled by a novel energy control system (ECS) adapted to optimize at least one of charging, discharging, temperature management, safety, security, maintenance, and anticipatory power delivery. The ECS may communicate with a user interface such as a display interface to assist in control or monitoring of the ESU and also may comprise a processor and a memory. The ECS may interact with the ESU's hardware, such as the charging/discharging hardware and a temperature control system that provides data to the ECS and responds to directions from the ECS to manage the ESU.

The energy control system (ECS) may comprise a processor, a memory, one or more energy source modules, a charge/discharge module, a communication module, a configuration module, a dynamic module, an identifier module, a security module, a safety module, a maintenance module, and a performance module.

### ECS Components and Modules

### Processor

The processor may comprise one or more microchips or other systems for executing electronic instructions and can provide instructions to regulate the charging and discharging hardware and, when applicable, the configuration hardware or other aspects of the ESU and other aspects of the ECS and its interactions with the device, the cloud, etc. In some cases, a plurality of processors may collaborate, including processors installed with the ESU and processors installed in a vehicle or other device.

### Memory

The memory may comprise coding to operate one or more of the ECS and their interactions with other components. It may also comprise information such as databases on any aspect of the operation of the ECS, though additional databases are also available via the cloud. Such databases can include a charging database that describes the charging and discharging characteristics of a plurality or all energy sources (the power packs and the batteries or other energy storage units) to guide charging and discharging operations. Such data may also be included with energy-source-specific data provided by or accessed by the energy source modules.

The memory may be in one or more locations or components such as a memory chip, a hard drive, a cloud-based source, or another computer-readable medium, and maybe in any application form such as flash memory, EPROM, EEPROM, PROM, MROM, etc., or combinations thereof and consolidated (centralized) or distributed forms. The memory may, in whole or part, be a read-only memory (ROM) or random-access memory (RAM), including static RAM (SRAM), dynamic RAM (DRAM), synchronous dynamic RAM (SDRAM), and magneto-resistive RAM (MRAM), etc.

### Cloud Resources

The ECS may communicate with other entities via the cloud or other means. Such communication may involve information received from and provided to one or more databases and a message center. The message center can provide alerts to an administrator responsible for the ESU and the electric vehicle or another device. For example, an entity may own a fleet of electric vehicles using ESUs and may wish to receive notifications regarding usage, performance, maintenance issues, and so forth. The message center may also authenticate the ESU or verify its authorization for use in the electric vehicle or other devices (not shown) via interaction with the security module.

### Energy Source Modules

The energy source modules may comprise specific modules designed to operate a specific energy source, such as a supercapacitor module, a lithium battery module, a lead-acid battery module, or other modules. Such modules may be associated with a database of performance characteristics (e.g., charge and discharge curves, safety restrictions regarding overcharge, temperature, etc.) that may provide information for use by the safety module and the charge/discharge module, which is used to optimize how each unit within the power packs or batteries or other energy storage units is used both in terms of charging and delivering charge. The charge/discharge module seeks to provide useful work from as much of the charge as possible in the individual power packs while ensuring that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

### Charge/Discharge Module

The charge/discharge module is used to optimize each unit within the power packs, batteries, or other energy storage units to charge and deliver charge. The charge/discharge module seeks to provide useful work from as much of the charge as possible in the individual power packs while ensuring during charging that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

The charge/discharge module may be configured to charge or discharge each of the plurality of power packs up to a threshold limit. The charge/discharge module may be coupled to the performance, energy storage, and identifier modules. It may communicate with the charging/discharging hardware of the ESU. For example, the threshold limit may be more than 90 percent capacity of each of the plurality of power packs in one aspect.

### Dynamic Module

The dynamic module assists in coping with changes in operation, including acceleration, deceleration, stops, changes in slops (uphill or downhill), changes in traction or properties of the road or ground that affect traction and performance, etc., by optimizing the delivery of power or the charging that is taking place for individual power packs or batteries or other energy storage units. In addition to guiding the degree of power provided by or to individual power packs based on the current use of the device and the individual state of the power packs, in some aspects, the dynamic module provides anticipatory management of the ESU by proactively adjusting the charging or discharging states of the power packs such that added power is available as the need arises or slightly in advance (depending on time constants for the ESU and its components, anticipatory changes in status may only be needed for a few seconds (e.g., 5 seconds or less or 2 seconds or less) or perhaps only for 1 second or less such as for 0.5 seconds or less. Still, more extended preparatory changes may be needed in other cases, such as from 3 seconds to 10 seconds, to ensure that adequate power is available when needed but that power is not wasted by changing the power delivery state prematurely. This anticipatory control can involve increasing the current or voltage being delivered. Still, it can also involve increasing the cooling provided by the cooling hardware of the charging and discharging hardware in cooperation with the safety module and when suitable with the charge/discharge module.

The dynamic module may be communicatively coupled to the charge/discharge module. The dynamic module may be configured to determine the charging and discharging status of the plurality of power packs and batteries or other energy storage units in real-time. For example, in one aspect, the dynamic module may help govern bidirectional charge/discharge in real-time. The electric charge may flow from the ESU into the plurality of power packs and batteries or other energy storage units or vice versa.

### Configuration Module

The ECS may comprise a configuration module configured to determine any change in the configuration of charged power packs from the charging module. For example, in one aspect, the configuration module may be provided to charge the configuration of the power packs, such as from series to parallel or vice versa. This may occur via communication with the charging/discharging hardware of the ESU.

### Identifier Module

The identifier module, described in more detail hereafter, identifies the charging or discharging requirement for each power pack to assist in best meeting the power supply needs of the device. This process may require access to the database information about the individual power packs from the energy source modules (e.g., a supercapacitor module) and information about the current state of the individual power packs provided by the sensors and charge and current detections circuits associated with the charging and discharging hardware, cooperating with the charge/discharge module and, as needed, with the dynamic module and the safety module.

### Safety Module

The sensors may communicate with the safety module to determine if the power packs and individual components show excessive local or system temperature signs that might harm the components. In such cases, the safety module interacts with the processor and other features (e.g., data stored in the databases of the cloud or memory pertaining to safe temperature characteristics for the ESU) to cause a change in operation such as decreasing the charging or discharging underway with the portions of the power packs or other units facing excessive temperature. The safety module may also regulate cooling systems that are part of the charging and discharging hardware to proactively increase the cooling of the power packs, batteries, or other energy storage units. Increasing the load on them does not lead to harmful temperature increases.

Thus, the safety module may also interact with the dynamic module in responding to forecasts of system demands in the near future for anticipatory control of the ESU for optimized power delivery. In the interaction with the dynamic module, the safety module may determine that an upcoming episode of high system demand such as imminent climbing of a hill may impose excessive demands on a power pack already operating at elevated temperature, and thus make a proactive recommendation to increase cooling on the at-risk power packs. Other sensors such as strain gauges, pressure gauges, chemical sensors, etc., may be provided to determine if any of the energy storage units in batteries or other energy storage units or the power packs are facing pressure buildup from outgassing, decomposition, corrosion, electrical shorts, unwanted chemical reactions such as an incipient runaway reaction, or other system difficulties. In such cases, the safety module may initiate precautionary or emergency procedures such as a shutdown, electrical isolation of the affected components, warnings to a system administrator via the communication module to the message center, a request for maintenance to the maintenance module.

### Maintenance Module

The maintenance module determines when the ESU requires maintenance, either per a predetermined scheduled or when needed due to apparent problems in performance, as may be flagged by the performance module, or in issues about safety as determined by the safety module based on data from sensors or the charging/discharging hardware, and in light of information from the energy sources modules. The maintenance module may cooperate with the communication module to provide relevant information to the display interface and the message center. An administrator or owner may initiate maintenance action in response to the message provided. The maintenance module may also initiate mitigating actions to be taken, such as cooperating with the charge/discharge module to decrease the demand on one or more of the power packs in need of maintenance and may also cooperate with the configuration module to reconfigure the power packs to reduce the demand in components that may be malfunctioning of near to malfunctioning to reduce harm and risk.

### Performance Module

The performance module continually monitors the results obtained with individual power packs and the batteries or other energy storage units and stores information as needed in memory and the cloud databases or via messages to the message center. The monitoring is done using the sensors and the charging/discharging hardware, etc. The tracking of performance attributes of the respective energy sources can guide knowledge about the system's health, the capabilities of the components, etc., which can guide decisions about charging and discharging in cooperation with the charge/discharge module. The performance module compares actual performance, such as power density, charge density, time to charge, thermal behavior, etc., to specifications and can then cooperate with the maintenance module to help determine if maintenance or replacement is needed and alert an administrator via the communication module with a message to the message center about apparent problems in product quality.

### Security Module: Security and Anti-Counterfeiting Measures

The security module helps reduce the risk of counterfeit products or theft or misuse of legitimate products associated with the ESU, thus including one or more methods for authenticating the nature of the ESU and authorization to use it with the device in question. Methods of reducing the risk of theft or unauthorized use of an ESU or its respective power packs can include locks integrated with the casing of the ESU that mechanically secure the ESU in the electric vehicle or other devices, wherein a key, a unique fob, a biometric signal such as a fingerprint or voice recognition system, or other security-related credentials or may be required to enable removal of the ESU or even operation thereof.

In another aspect, the ESU comprises a unique identifier (not shown) that can be tracked, allowing a security system to verify that a given ESU is authorized for use with the device, such as an electric vehicle or other devices. For example, the casing of the ESU or one or more power packs therein may have a unique identifier attached, such as an RFID tag with a serial number (an active or passive tag), a holographic tag with unique characteristics equivalent to a serial number or password, nanoparticle markings that convey a unique signal, etc. One good security tool that may be adapted for the security of the ESU is a seemingly ordinary bar code or QR code with unique characteristics not visible to the human eye that cannot be readily copied that essentially allows ordinary QR codes and barcodes to become unique, individual codes by analysis of tiny imperfections in the printing to uniquely and robustly identify every individual product, even if it seems that the same code is printed on every one.

Yet another approach relies at least in part on the unique electronic signature of the ESU and one or more individual power packs or of one or more supercapacitor units therein. The principle will be described relative to an individual power pack but may be adapted to an individual supercapacitor or collectively to the ESU as a whole. When a power pack comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack may then be tested using any suitable tool capable of identifying a signature specific to the individual power pack.

### Communication Module

The communication module can govern communications between the ECS and the outside world, including communications through the cloud, such as making queries and receiving data from various external databases or sending messages to a message center where they may be processed and archived by an administrator, a device owner, the device user, the ESU owner, or automated systems. In some aspects, the communication module may also oversee communication between modules or between the ESU and the ECS and work in cooperation with various modules to direct information to and from the display interface. Communications within a vehicle or between the ECS or ESU and the device may involve a DC bus or other means such as separate wiring. Any suitable protocol may be used, including UART, LIN (or DC-LIN), CAN, SPI, I2C (including Intel's SMBus), and DMX (e.g., DMX512). In general, communications from the ECS or ESU with a device may be over a DC bus or, if needed, over an AC/DC bus, or by separately wired pathways if desired, or wireless.

Communication to the cloud may occur via the communication module and involve wired or wireless connections. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

### Electrostatic Module

Assessment of charge in an energy storage unit can be conducted based on measurements made with the charging/discharging hardware in communication with specific modules of the ECS. In general, an electrostatic module can manage the measurement of charge and processing of the data.

The electrostatic module may be configured to identify the power pack type and the capacity of each power pack connected to the modular multi-type power pack energy storage unit. Further, the electrostatic module may be configured to retrieve information related to the type of power packs from the charging database. The electrostatic module may determine the capacity of each power pack to be charged. It may be configured to determine the capacity of each power pack when connected to the modular multi-type power pack ESU.

The electrostatic module may be configured to determine if each power pack charged below the threshold limit. For example, in one aspect, the electrostatic module may check whether each of the plurality of power packs may have a capacity below the threshold limit. The electrostatic module may also be configured to send data related to power packs to the ECS.

### Various Databases

The ECS may access various databases via an interface to the cloud and store retrieved information in the memory to guide the various modules.

Further, the memory may comprise a charging database or information from such a database obtained from the databases or the cloud. In one aspect, the charging database may be configured to store information related to various power packs used while charging and discharging from the ESU. In one aspect, the charging database may be configured to store information related to the power cycle of each of the plurality of power packs, the maximum and minimum charge for different types of power packs, and the state of charge (SoC) profile of each of the plurality of power packs.

The charging database may be configured to store information related to managing the plurality of power packs, such as the type of power pack to be charged, safety specifications, recent performance data, bidirectional charging requirements, or history of each of the plurality of power packs, etc. In another aspect, the stored information may also include, but is not limited to, the capacity of each of the plurality of power packs, amount of charge required for one trip of the electric vehicle along the path, such as golf course, etc., charging required for a supercapacitor unit, etc. In another aspect, the charging database may provide a detailed research report for the electric vehicle's average electric charge consumption over a path. In one aspect, the charging database may be configured to store information of the consumption of the electric charge per unit per kilometer drive of the electric vehicle from the plurality of power packs. For example, such information may indicate that a golf cart is equipped with five supercapacitor-driven power packs each at 90% charge, with each power packable to supply a specified amount of ampere-hours (Ah) of electric charge resulting in an ability to drive under normal conditions at top speed for, say, 80 kilometers. The information may also indicate that a solar cell installed on the roof of the golf cart would, under current partly clouded conditions, still provide enough additional charge over the planned period of use to extend the capacity of the ESU by another 40 kilometers for one passenger.

The performance module may use the charging database to read data and store new data on the individual energy storage units such as the power packs.

### Power Pack

A power pack is a unit that can store and deliver charge within an energy storage unit and comprises one or more supercapacitors such as supercapacitors in series and parallel. It may further comprise or cooperate with temperature sensors, charge and current sensors (circuits or other devices), connectors, switches such as crosspoint switches, safety devices, and control systems such as charge and discharge control systems. In various aspects described herein, the power pack may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack may have a functional temperature range from −70° C. to +° C., such as from −50° C. to ° C. or from −40° C. to 80° C. The voltage provided by the power pack may be any practical value such as 3V or more significant, such as from 3V to 240 V, 4V to 120 V, etc.

By way of example, a power pack may comprise one or more units, each comprising at least one supercapacitor having a nominal voltage from 2 to 12 V, such as from 3 to 6 V, including supercapacitors rated at about 3, 3.5, 4, 4.2, 4.5, and 5 V. For example, in discharge testing, a power pack was provided and tested with 14 capacitors in series and five series in parallel charged with 21,000F at 4.2 V and had 68-75 Wh. Power packs may be packaged in protective casings that can easily be removed from an ESU and replaced. They may also comprise connectors for charging and discharging. Power packs may be provided with generally rectilinear casings, or they may have cylindrical or other useful shapes.

### Supercapacitor Information

### Supercapacitors

A supercapacitor may have two electrode layers separated by an electrode separator wherein each electrode layer is electrically connected to a current collector supported upon an inert substrate layer; further comprising an electrolyte-impervious layer disposed between each electrode layer and each conducting layer to protect the conducting layer, and a liquid electrolyte disposed within the area occupied by the active electrode layers and the electrode separator. To inhibit electrolyte flow, the liquid electrolyte may be an ionic liquid electrolyte gelled by a silica gellant or other gellant.

The supercapacitor may comprise an electrode plate, an isolation film, a pole, and a shell. The electrode plate comprises a current collector, and a coating is disposed of on the current collector. The coating may comprise an active material that may include carbon nanomaterial such as graphene or carbon nanotubes, including nitrogen-doped graphene, a carbon nitride, carbon materials doped with a sulfur compound such as thiophene or poly 3-hexylthiophene, etc., or graphene on which is deposited nanoparticles of metal oxide such as manganese dioxide. The coating may further comprise a conductive polymer such as one or more polyaniline, polythiophene, and polypyrrole. Such polymers may be doped with various substances such as boron (especially in the case of polyaniline).

Electrodes in supercapacitors may have thin coatings in electrical communication with a current collector, to provide high electrode surface area for high performance, electrodes may comprise porous material with a high specific surface area such as graphene, graphene oxide, or various derivatives of graphene, carbon nanotubes or other carbon nanomaterials including activated carbon, nitrogen-doped graphene or another doped graphene, graphite, carbon fiber-cloth, carbide-derived carbon, carbon aerogel. They may comprise various metal oxides such as oxides of manganese, etc. All such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors about charge state, temperature, and other performance and safety aspects. An actuation mechanism may be integrated to prevent undesired discharge.

The voltage of an individual supercapacitor may be greater than 2 V, such as from 2.5 V to 5 V, 2.7 V to 8 V, 2.5 V to 4.5 V, etc.

Supercapacitors can be divided into units of smaller supercapacitors. In one embodiment, a “constant voltage unit” of five units can be joined together in parallel to maintain the voltage but supply five times more current. In another embodiment, a “constant current unity” can include five units joined together in series to multiply the unit voltage by five times but maintain the current. In another embodiment, supercapacitors can provide hybrid “constant voltage units” and “constant current units.” In yet another embodiment, supercapacitors units can be connected in any number of combinations to end up with a supercapacitor of optimum design. In another embodiment, each supercapacitor unit can comprise various subunits or pouches. Supercapacitor subunits can be combined using constant current, voltage, or any combination. Supercapacitor units or sub-units can comprise size or form factors in yet another embodiment. In yet another embodiment, each subunit and unit can be uniquely addressed to turn on or off the supercapacitor unit or sub-unit on or off. This is achieved with any variety of crossbar switches.

A crossbar switch is an assembly of individual switches between inputs and a set of outputs. The switches are arranged in a matrix. If the crossbar switch has M inputs and N outputs, then a crossbar has a matrix with M×N cross-points or places where the connections cross. At each crosspoint is a switch; when closed, it connects one of the inputs to one of the outputs. A given crossbar is a single layer, non-blocking Switch. A non-blocking switch means that other concurrent connections do not prevent connecting other inputs to other outputs. Collections of crossbars can be used to implement multiple layers and blocking switches. A crossbar switching system is also called a coordinate switching system. In this way, a crossbar switch can select any combinations of pouches or subunits and units to obtain any combination. The crossbar switches can be used to test units or subunits and optimize supercapacitor performance.

### Powered Devices and Electric Vehicles, etc.

Powered devices powered by the ESU can include electric vehicles and other transportation devices of all kinds, such as those for land, water, or air, whether adapted to operate without passengers or with one or more passengers. Electric vehicles may include automobiles, trucks, vans, forklifts, carts such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like, etc. The electric vehicle generally comprises one or more motors connected to the ESU and an energy control system (ECS) that controls the power delivered from the ESU and may comprise a user interface that provides information and control regarding the delivery of power from the ESU as well as information regarding performance, remaining charge, safety, maintenance, security, etc. Not all transportation devices require non-stationary motors. An elevator, for example, may have a substantially stationary motor while the cabin moves between the level of a structure. Other transport systems with mobile cabins, seats, or walkways may be driven by stationary motors driving cables, chains, gears, bands, etc.

Apart from electric vehicles, there are many other devices that the ESU may power in cooperation with the ESC. Such other devices can include generators, which in turn can power an endless list of electric devices in households and industry. ESUs of various sizes and shapes can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the powered device is the grid, and in such versions, the ESU may comprise an inverter to turn DC into AC suitable for the grid.

In some aspects, a plurality of devices such as electric vehicles may be networked together via a cloud-based network, wherein the devices share information among themselves and with a central message center such that an administrator can assist in managing the allocation of resources, oversee maintenance, evaluate the performance of vehicles and ESUs, upgrade software or firmware associated with the ESC to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU may comprise both power packs and one or more lead-acid batteries or other batteries. The ESU may power both the motor and the onboard power supply system. The display interface of the associated ESC may comprise a graphical user interface such as the vehicle's control panel (e.g., a touch panel). The display interface may also comprise audio information and verbal input from a user.

### Motors

The ESU may power any electric motor. The major classes of electric motors are: 1) DC motors, such as series, shunt, compound wound, separately excited (wherein the connection of stator and rotor is made using a different power supply for each), brushless, and PMDC (permanent magnet DC) motors, 2) AC motors such as synchronous, asynchronous, and induction motors (sometimes also called asynchronous motors), and 3) special purpose motors such as servo, stepper, linear induction, hysteresis, universal (a series-wound electric motor that can operate on AC and DC power), and reluctance motors.

### Display Interface

The display interface of the ESC may be displayed on or in the device, such as on a touch screen or other display in a vehicle or on the device, or it may be displayed by a separate device such as the user's phone. The display interface may comprise or be part of a graphic user interface such as the vehicle's control panel (e.g., a touch panel). The display interface may also comprise audio information and verbal input from a user. It may also be displayed on the ESU itself or a surface connected to or communicated with the ESU. In one version, the display interface may include but is not limited to a video monitoring display, a smartphone, a tablet, and the like, each capable of displaying a variety of parameters and interactive controls. Still, the display could also be as simple as one or more lights indicating charging or discharging status and optionally one or more digital or analog indicators showing remaining useful lifetime, % power remaining, voltage, etc.

Further, the display interface may be any state-of-the-art display means without departing from the scope of the disclosure. In some aspects, the display interface provides graphical information on charge status, including one or more fractions of charge remaining or consumed, remaining useful life of the ESU or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU for shipping, discharge the ESU, increase active cooling, only apply low power, etc.); planned conditions for use (e.g., outdoors, high-humidity, in the rain, underwater, indoors, etc.). Selections may be made through menus and buttons on a visual display, through audio “display” of information responsive to verbal commands, or through text commands or displays transmitted to a phone or computer, including text messages or visual display via an app or web page.

Thus, the ESU may comprise a display interface coupled to the processor to continuously display the status of charging and discharging the plurality of power packs.

### General:

All patents and applications cited must be understood as being incorporated by reference to their compatible degree.

For all ranges given herein, it should be understood that any lower limit may be combined with any upper limit when feasible. Thus, for example, citing a temperature range of from 5° C. to ° C. and from 20° C. to 200° C. would also inherently include a range of from 5° C. to 200° C. and a range of 20° C. to ° C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

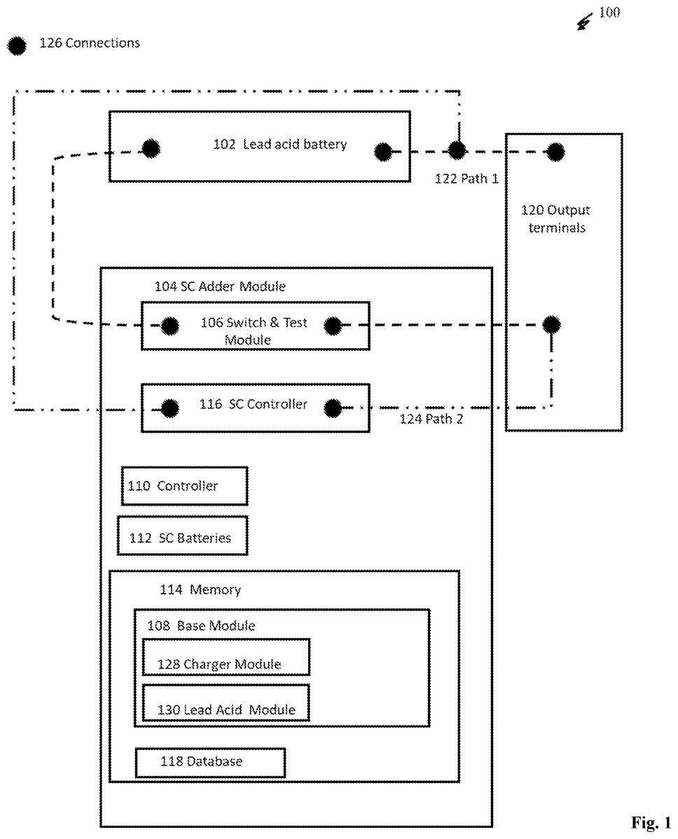

FIG. 1 is a block diagram illustrating a system 100 for a hybrid battery that includes at least one supercapacitor and at least one lead-acid battery. This system comprises of Lead-acid battery 102 that is integrated with the SC Adder Module 104. Further, SC Adder Module 104 is a self-contained unit with 2 output terminals 120. SC adder Module integrates a supercapacitor battery 112 with a lead-acid battery 102 in the same package with a form factor equal to a normal lead-acid battery. The supercapacitor battery 112 is integrated into an SC adder Module 104 and is isolated from the lead-acid battery 102. The lead-acid battery 102 and supercapacitor batteries 112 used connections 126 are made within the housing. Only the lead-acid battery 102 cells for filing and output terminals 120 are available to the user. SC Adder Module 104 has a higher capacity than electrochemical batteries as they deliver charges at a much smaller weight and size. SC Adder Module 104 comprises Supercapacitor batteries (SC Batteries 112) and contains a control system to connect to output terminals 120 and manage to charge. SC Adder Module 104 uses SC Controller 116 to switch in and out the SC batteries 112 to output terminals 120 as needed. The SC Adder module contains a memory 114 and a base module 108 that controls the charger Module 128. Also, SC Adder Module 104 runs Lead Acid Module 130. SC Adder Module 104 has a database 118 that stores and uses all relevant information to the Charger Module 128 and the Lead-acid Module 120. SC Adder Module 104 has controller 110 that executes instructions from Memory 114. Further, Switch and Test module 106 allows amperage measurement in path 1 to see how much amperage is drawn through Lead Acid Battery 102 and output terminals 120. Switch and Test module 106 can also be instructed to disconnect or connect lead-acid battery 102 using a digitally controlled high-powered relay. Switch and Test module 106 can also operate in milliseconds so that switching cause output terminals 120 smooth operations. Base Module 108 switches off Path 2 124, ensuring SC batteries 112 are disconnected, using SC Controller 116. Base Module 108 switches on Path 1 122, ensuring lead-acid battery 102 are connected to output terminals 120, using Switch and a Test module 106. Base Module 108 polls and measuring if lead-acid battery 102, if lead-acid battery 102 is below a threshold, disconnect path 1 122 disconnecting lead-acid battery 102 and connect path 2 124 to hook up supercapacitor batteries 112 to output terminals 120 using SC Controller 116 and execute Lead-acid module 130. Base Module 108 polls and measures if output terminals 120 are charged, execute charger module 128. Base Module 108 loops back. Further, Controller 110 is a processor to execute commands in memory 114 from Base Module 108, allows access (reading and writing the database 118), and allows instruction to turn on and off SC Controller 116. Controller 110 also allows for current measurements from path 1 to be collected and stored (in real-time) in database 118. Controller 110 also controls the switching of the high-powered switching relay in path 1 as base module 108 executes. SC Batteries 112 are any type or group of Supercapacitor batteries designed to have enough capacity to run devices connected to output terminals 120. Memory 114 is designed to operate the storage of Base Module 108 and its sub-modules and Database 118. Further, SC Controller 116 polls Base Module 108. SC Controller 116 determines if Base Module 108 executes SC Controller Module 116 to switch in or out between the SC Batteries 112 to electric vehicle 120 by path 1 (not shown this is done with a high-powered switching relay). SC Controller 116 determines if Base Module 108 executes SC Controller Module 116 to switch between SC Batteries 112. Database 118 allows reading and writing data from Base Module 108 and their sub-modules and data associated with Switch and Test Module 116 and SC Controller 116. Database 118 also stores the recommended max charging energy or amperage for SC batteries 112. Database 118 also stores all needed wait times and charge times used by Charger Module 128 and Lead-Acid Module 130. Output 120 are the two normal output + and − terminals connected to external devices. Path 1 122 shows connections between output terminals 120 and lead-acid Battery 102, which is interrupted by SC Adder Module 104. Path 2 124 shows connections between output terminals 120 and SC Controller 116, allowing the flow of charge from SC batteries 112 to output terminals 120. Connection 126 shows terminals (such as those found as battery terminals to connect SC Adder Module 104 into the system 100). The connections of lead-acid battery 102, switch and test module 106, and SC controller 116 are unavailable to the user. Further, Charger Module 128 executing from the base module 108. It is assumed supercapacitor battery 112 loop Path 1 122 is on and connected (being charged) by an external charger (not shown). Charger Module 128 measures SC Batteries 112, and if the need for a charge, proceed to the charge operation, else return to Base Module 108. Charger Module 128 allows charging of SC batteries 112 until>a threshold charge is met or the charging period is up. The threshold charge is a full charge safety threshold stored and retrieved from database 118. The charging period is a time that ensures the SC battery 112 can get an external charger is running. This waiting period could be set as a conservative time, say 5 minutes, or set by using machine learning and Artificial Intelligence (not shown) to evaluate the charging by patterns and use the best patterns for charging SC Batteries 112. Charger Module 128 allows charging of Lead-acid battery 102 until >a threshold charge is met or the charging period is up. Note lead-acid battery 102 is charged. Charger Module 128 returns to Base module 108. Further, Lead-acid module 130 executes from Base Module 108, as the polling and measuring if lead-acid battery 102 showed lead-acid battery 102 is below a threshold and disconnect path 1 122 disconnecting lead-acid battery 102 and connect path 2 124 to hook up supercapacitor batteries 112 to output terminals 120 using SC Controller 116 and execute Lead-acid module 130. Lead-acid module 130 reads all data in database 118. Lead-acid module 130 transforms SC Battery 112 output into a Lead Acid Discharge Model. In one embodiment, a lead-acid discharge profile (e.g., battery voltage vs. capacity used) previously stored in database 118 is used to be matched. This is achieved by a matching module (not shown) that switches in and out supercapacitor group to create the correct voltage for the expected capacity loss. This is required so that the output terminals 120 (connected device golf cart, automobile) with supporting charging and regeneration technology (not shown) can work as if a lead-acid battery is connected. In other embodiments, the supercapacitor battery 112 could act as a top-off cell to provide extra energy for cold starts. It should be noted there are many uses for a hybrid supercapacitor and lead-acid battery.

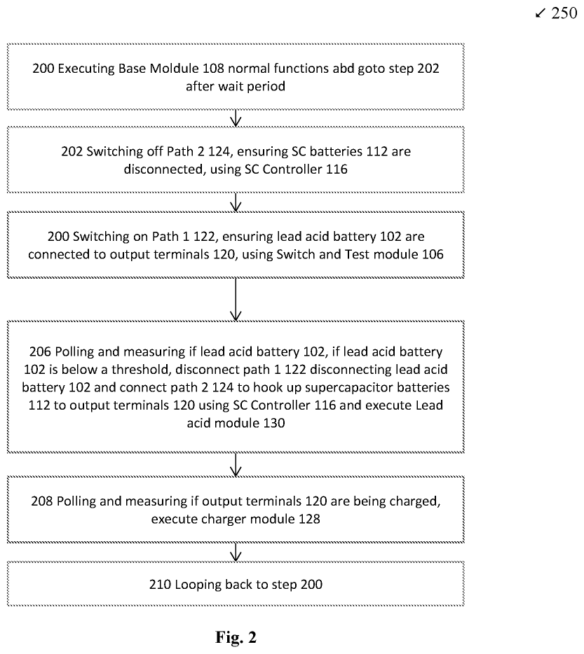

Functioning of the “Base Module” will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 2 is a flow diagram illustrating a process 250 performed using the Base Module 108. The process begins with Base Module 108 executing Base Module 108 normal functions and goto operation 202 after the waiting period, at operation 200. Base Module 108 switches off Path 2 124, ensuring SC batteries 112 are disconnected, using SC Controller 116, at operation 202. Base Module 108 switches on Path 1 122, ensuring lead-acid battery 102 are connected to output terminals 120, using Switch and a Test module 106, at operation 204. Base Module 108 polls and measuring if lead-acid battery 102, if lead-acid battery 102 is below a threshold, disconnect path 1 122 disconnecting lead-acid battery 102 and connect path 2 124 to hook up supercapacitor batteries 112 to output terminals 120 using SC Controller 116 and execute Lead-acid module 130, at operation 206. Base Module 108 polls and measures if output terminals 120 are charged, execute charger module 128, at operation 208. Base Module 108 loops back to operation 200 at operation 210.

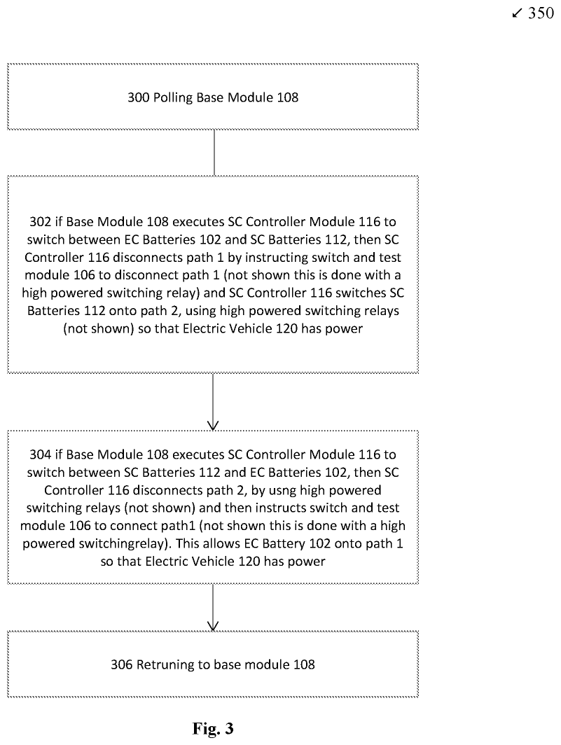

Functioning of the “SC Controller” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 is a flow diagram illustrating a process 350 performed using the SC Controller 116 operation. The process begins with SC Controller 116 polls Base Module 108, at operation 300. SC Controller 116 determines if Base Module 108 executes SC Controller Module 116 to switch between EC Batteries 102 and SC Batteries 112, then SC Controller 116 disconnects path 1 by instructing Switch and test module 106 to disconnect path 1 (not shown this is done with a high powered switching relay) and SC Controller 116 switches SC Batteries 112 onto path 2, using high powered switching relays (not shown) so that Electric Vehicle 120 has power, at operation 302. SC Controller 116 determines if Base Module 108 executes SC Controller Module 116 to switch between SC Batteries 112 and EC Batteries 102. SC Controller 116 disconnects path two using high-powered switching relays (not shown) and then instructs switch and test module 106 to connect path1 (not shown; this is done with a high-powered switching relay). This allows EC Battery 102 onto path 1 so that Electric Vehicle 120 has power at operation 304. SC Controller Module 116 then returns control to Base Module 108 at operation 306.

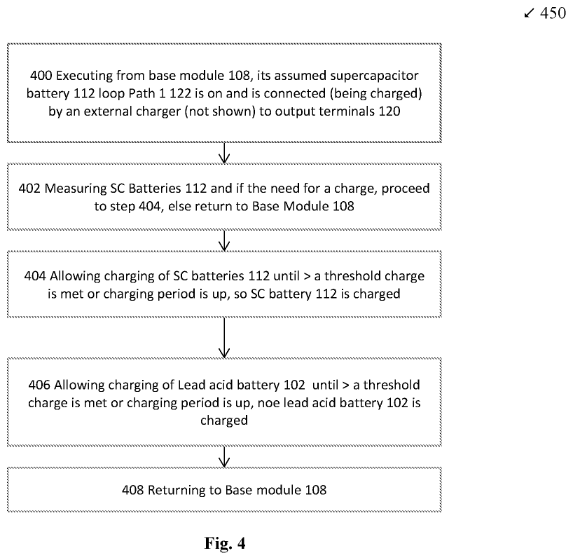

Functioning of the “Charger Module” will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 4 is a flow diagram illustrating a process 450 performed using the Charger Module 128. The process begins with Charger Module 400 executing from the base module 108. It is assumed supercapacitor battery 112 loop Path 1 122 is on and connected (being charged) by an external charger (not shown) at operation 400. Charger Module 400 measures SC Batteries 112, and if the need for a charge, proceed to operation 404, else return to Base Module 108, at operation 402. Charger Module 400 allows charging of SC batteries 112 until>a threshold charge is met or the charging period is up. The threshold charge is a full charge safety threshold stored and retrieved from database 118. The charging period is a time that ensures the SC battery 112 can get an external charger is running. This waiting period could be set as a conservative time, say 5 minutes, or it could be set by using machine learning and Artificial Intelligence (not shown) to evaluate the charging by patterns and use the best patterns for charging SC Batteries 112, at operation 404. Charger Module 400 allows charging of Lead-acid battery 102 until>a threshold charge is met or the charging period is up. Note lead-acid battery 102 is charged at operation 406. Charger Module 400 returns to Base module 108, at operation 408.

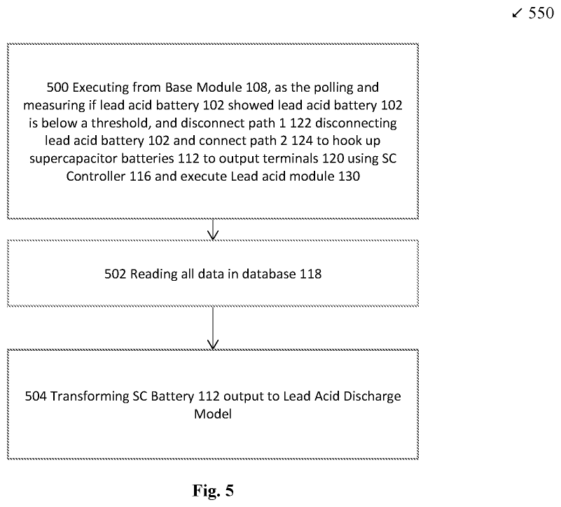

Functioning of the “Lead Acid Module” will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 5 is a flow diagram illustrating a process 550 performed using the Lead Acid Module. The process begins with Lead-acid module 130 executes from Base Module 108, as the polling and measuring if lead-acid battery 102 showed lead-acid battery 102 is below a threshold, and disconnect path 1 122 disconnecting lead-acid battery 102 and connect path 2 124 to hook up supercapacitor batteries 112 to output terminals 120 using SC Controller 116 and execute Lead-acid module 130, at operation 500. Lead-acid module 130 reads all data in database 118 at operation 502. Lead-acid module 130 transforms SC Battery 112 output into a Lead Acid Discharge Model. In one embodiment, a lead-acid discharge profile (e.g., battery voltage vs. capacity used) previously stored in database 118 is used to be matched. This is achieved by a matching module (not shown) that switches in and out supercapacitor group to create the correct voltage for the expected capacity loss. This is required so that the output terminals 120 (connected device golf cart, automobile) with supporting charging and regeneration technology (not shown) can work as if a lead-acid battery is connected. In other embodiments, the supercapacitor battery 112 could act as a top-off cell to provide extra energy for cold starts. It should be noted there are many uses for a hybrid supercapacitor and lead-acid battery, at operation 504.

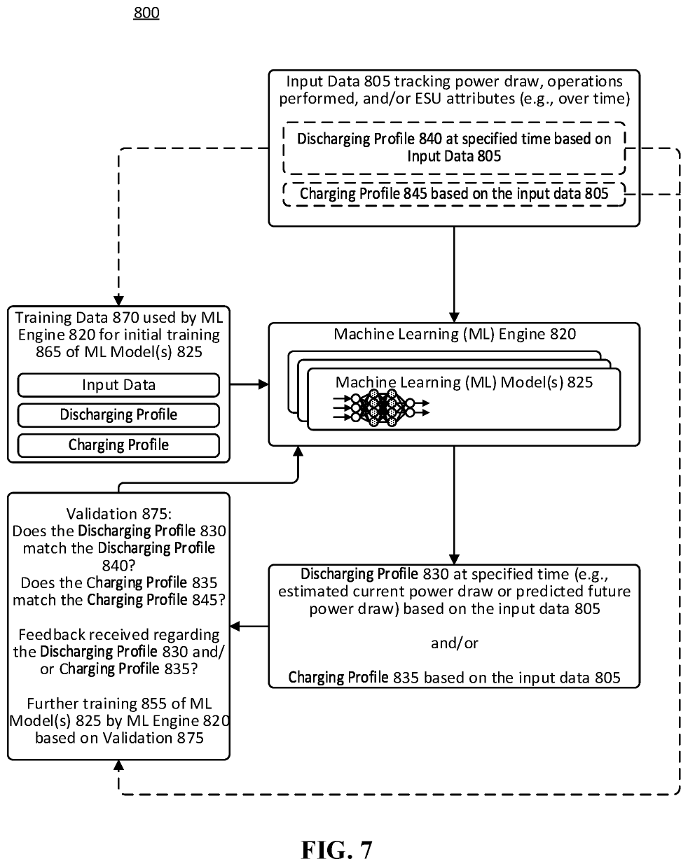

FIG. 7 is a block diagram illustrating a switch 605 controlled by a controller 615 that toggles between a first configuration in which output terminals 120 draw power from an lead-acid battery 102 and a second configuration in which the output terminals 120 draw power from a supercapacitor battery 112. The output terminals 120 can be coupled to a vehicle or components of a vehicle, such as a propulsion mechanism (e.g., engine and/or motor and/or other actuator), headlights, windshield wipers, radio, speakers, power brakes, power steering, display, camera, sensors, and the like. The first configuration is illustrated by a dashed line to the left, connecting the Lead-Acid battery 102 to the output terminals 120, and disconnecting the SC battery 112 from the output terminals 120. The second configuration is illustrated by a dashed line to the right, connecting the SC battery 112 to output terminals 120, and disconnecting the Lead-Acid battery 102 from the output terminals 120. The toggling of the switch 605 between the two configurations can be controlled by the controller 615, which can be an example of the energy management system 100, the SC adder module 104, the switch and test module 106, the SC controller 116, the controller 110, the memory 114, the base module 108, the database 118, or a combination thereof. The switch 605 can be a mechanical switch, a Single Pole Single Throw (SPST) switch, a Single Pole Double Throw (SPDT) switch, a Double Pole Single Throw (DPST) switch, a Double Pole Double Throw (DPDT) switch, a toggle switch, a transistor switch, an NPN transistor switch, a PNP transistor switch, an H-bridge switch, or a combination thereof.

FIG. 7 is a block diagram 800 illustrating use of one or more trained machine learning models 825 of a machine learning engine 820 to identify a discharging profile 830 and/or a charging profile 835, for instance to estimate a current discharging profile or predict a future discharging profile. The ML engine 820 and/or the ML model(s) 825 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 7, a graphic representing the trained ML model(s) 825 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 820 and/or the ML model(s) 825 can be part of the AI/ML module 182.

Once trained via initial training 865, the one or more ML models 825 receive, as an input, input data 805 that identifies discharging profile by various components and/or subsystems of a system (e.g., of a vehicle), for instance tracking discharging profile by various components and/or subsystems of the system (e.g., of the vehicle) over time. In some examples, the input data 805 identifies operation(s) and/or processes that are performed using the various components and/or subsystems of the system (e.g., of the vehicle) using the tracked power over time. In some examples, the input data 805 identifies attribute(s) of charging and/or discharging and/or capabilities of an energy storage unit (ESU) (e.g., type, voltage, discharge curve, capacitance, impedance, current, amperage, capacity, energy density, specific energy density, power density, temperature, temperature dependence, service life, physical attributes, charge cycle, discharge cycle, cycle life, deep discharge ability, discharge rate, charge rate, and the like), attribute(s) of the components and/or subsystems of the system (e.g., of the vehicle) that draw charge from the ESU, attribute(s) of the system (e.g., of the vehicle) that includes the ESU and draws charge from the ESU (e.g., mileage, efficiency, ergonomics, aerodynamics, shape, geometry, weight, horsepower, brake power, turning radius, type, size, energy consumption rate, location, speed, velocity, acceleration, deceleration, turning radius, and the like), or a combination thereof.

At least some of the input data 805 may be received from one or more sensors, such as sensors to measure voltage, current, resistance, capacitance, inductance, frequency, power, temperature, continuity, location, motion, acceleration, deceleration, orientation, changes to any of these attributes, or a combination thereof. In some examples, the one or more sensors can include one or more voltmeters, ammeters, ohmmeters, capacimeters, inductance meters, wattmeters, thermometers, thermistors, multimeters, accelerometers, gyrometers, gyroscopes, global navigation satellite system (GNSS) receivers, inertial measurement units (IMUs), or a combination thereof In some examples, the input data 805 may be received from a one or more databases, such as the database 118, where at least some of the input data 805 may be stored after measurement by the sensors. In some examples, the input data 805 can also include information that is indicative of total capacity of the ESU, the remaining charge and/or remaining capacity of the ESU, a level of shade or shadows that could prevent solar cells from generating charge from light (e.g., whether or not shade or shadows are blocking solar cells to prevent solar charging), a route of the vehicle, a schedule trip of the vehicle, elevation data indicative of uphill and/or downhill portions of a route of the vehicle, or a combination thereof. In some examples, for instance during validation 875, the ML engine 820 and/or the one or more ML models 825 can also receive, as an additional input, a predetermined discharging profile 840 (e.g., current discharging profile or predicted future discharging profile) that is based on (or otherwise corresponds to) the input data 805. In response to receiving at least the input data 805 as an input(s), the one or more ML model(s) 825 estimate the discharging profile 830 (e.g., current discharging profile or predicted future discharging profile) based on the input data 805. In some examples, for instance during validation 875, the ML engine 820 and/or the one or more ML models 825 can also receive, as an additional input, a predetermined charging profile 845 (e.g., beyond which charging profile becomes risky or dangerous due to risk) that is based on (or otherwise corresponds to) the input data 805. In response to receiving at least the input data 805 as an input(s), the one or more ML model(s) 825 can estimate the charging profile 835 based on the input data 805. The discharging profile 830 (e.g., current discharging profile or predicted future discharging profile) and charging profile 835 can indicate an amount of power charged, a rate at which power is returned, and the like. The discharging profile and charging profile can each be indicated in terms of voltage, current, resistance, capacitance, inductance, frequency, power, amperage, capacity, energy density, specific energy density, power density, charge cycle, discharge cycle, cycle life, deep discharge ability, discharge rate, charge rate, or a combination thereof. The discharging profile and charging profile can each be indicated in units of watts, amps, volts, ohms, joules, farads, henries, any of the previously-listed units measured per distance or area (e.g., per meter or per meter squared), any of the previously-listed units measured per unit of time (e.g., per second or per second squared), or a combination thereof.

Identifying the discharging profile 830 (e.g., estimated current discharging profile or predicted future discharging profile) and/or the charging profile 835 can correspond to at least operations 202, 204, 206, 208, 302, 304, 400, 402, 404, 406, 500, 502, 504, 910, 915, and/or 920. It should be understood that the pre-determined discharging profile 840 and/or the pre-determined charging profile 845 can likewise include any of the types of charging and dischargin information listed above with respect to the discharging profile 830 and/or the charging profile 835.

Once the one or more ML models 825 identify the discharging profile 830 and/or the charging profile 835, the discharging profile 830 and/or the charging profile 835 can be output to an output interface that can indicate the discharging profile 830 and/or the charging profile 835 to a user (e.g., by displaying the discharging profile 830 and/or the charging profile 835 or playing audio indicative of the discharging profile 830 and/or the charging profile 835) and/or to the system 100, which can adjust settings and/or configurations for the system 100, for instance to switch (e.g., as in operation 920) between a first configuration in which components and/or subsystems (e.g., the propulsion system of the vehicle) draw power from a lead-acid battery (and disconnects a supercapacitor from providing power to those components and/or subsystems) and a second configuration in which the components and/or subsystems (e.g., the propulsion system of the vehicle) draw power from a supercapacitor (and disconnects the lead-acid battery from providing power to those components and/or subsystems).

Before using the one or more ML models 825 to identify the discharging profile 830 and/or the charging profile 835, the ML engine 820 performs initial training 865 of the one or more ML models 825 using training data 870. The training data 870 can include examples of the input data tracking discharging profile and/or ESU attributes and/or operations over time (e.g., as in the input data 805), examples of a pre-determined discharging profile (e.g., as in the pre-determined discharging profile 840), and/or examples of a pre-determined charging profile(s) (e.g., as in the pre-determined charging profile 845). In some examples, the pre-determined discharging profile in the training data 870 are discharging profile(s) that the one or more ML models 825 previously identified based on the input data in the training data 870. In some examples, the pre-determined charging profile in the training data 870 are charging profile(s) that the one or more ML models 825 previously identified based on the input data in the training data 870. In the initial training 865, the ML engine 820 can form connections and/or weights based on the training data 870, for instance between nodes of a neural network or another form of neural network. For instance, in the initial training 865, the ML engine 820 can be trained to output the pre-determined discharging profile and/or the pre-determined charging profile in the training data 870 in response to receipt of the corresponding input data in the training data 870.

During a validation 875 of the initial training 865 (and/or further training 855), the input data 805 (and/or the exemplary input data in the training data 870) is input into the one or more ML models 825 to identify the discharging profile 830 and/or the charging profile 835 as described above. The ML engine 820 performs validation 875 at least in part by determining whether the identified discharging profile 830 and/or the identified charging profile 835 matches the pre-determined discharging profile 840 (and/or the pre-determined discharging profile in the training data 870) and/or the pre-determined charging profile 845 (and/or the pre-determined charging profile in the training data 870). If, during validation 875, the discharging profile 830 matches the pre-determined discharging profile 840 and/or if the charging profile 835 matches the pre-determined charging profile 845, then the ML engine 820 performs further training 855 of the one or more ML models 825 by updating the one or more ML models 825 to reinforce weights and/or connections within the one or more ML models 825 that contributed to the identification of the discharging profile 830 and/or the charging profile 835, encouraging the one or more ML models 825 to make similar discharging profile and/or charging profile determinations given similar inputs. If, during validation 875, the discharging profile 830 and/or the charging profile 835 does not match the pre-determined discharging profile 840 and/or the pre-determined charging profile 845, then the ML engine 820 performs further training 855 of the one or more ML models 825 by updating the one or more ML models 825 to weaken, remove, and/or replace weights and/or connections within the one or more ML models that contributed to the identification of the discharging profile 830 and/or the charging profile 835, discouraging the one or more ML models 825 from making similar discharging profile and/or charging profile determinations given similar inputs.

Validation 875 and further training 855 of the one or more ML models 825 can continue once the one or more ML models 825 are in use based on feedback 850 received regarding the discharging profile 830 and/or the charging profile 835. In some examples, the feedback 850 can be received from a user via a user interface, for instance via an input from the user interface that approves or declines use of the discharging profile 830 and/or the charging profile 835. In some examples, the feedback 850 can be received from another component or subsystem of the vehicle (e.g., an energy control system), for instance based on whether the component or subsystem successfully uses the discharging profile 830 and/or the charging profile 835, whether use the discharging profile 830 and/or the charging profile 835 causes any problems for the component or subsystem (e.g., which may be detected using the sensors), whether use the discharging profile 830 and/or the charging profile 835 are accurate, or a combination thereof. If the feedback 850 is positive (e.g., expresses, indicates, and/or suggests approval of the discharging profile 830 and/or the charging profile 835, success of the discharging profile 830 and/or the charging profile 835, and/or accuracy the discharging profile 830 and/or the charging profile 835), then the ML engine 820 performs further training 855 of the one or more ML models 825 by updating the one or more ML models 825 to reinforce weights and/or connections within the one or more ML models 825 that contributed to the identification of the discharging profile 830, encouraging the one or more ML models 825 to make similar discharging profile determinations given similar inputs. If the feedback 850 is negative (e.g., expresses, indicates, and/or suggests disapproval of the discharging profile 830 and/or the charging profile 835, failure of the discharging profile 830 and/or the charging profile 835, and/or inaccuracy of the discharging profile 830 and/or the charging profile 835) then the ML engine 820 performs further training 855 of the one or more ML models 825 by updating the one or more ML models 825 to weaken, remove, and/or replace weights and/or connections within the one or more ML models that contributed to the identification of the discharging profile 830 and/or the charging profile 835, discouraging the one or more ML models 825 to make similar discharging profile and/or charging profile determinations given similar inputs.

FIG. 9 is a flow diagram illustrating a process 900 using a controller for charging and/or discharging a hybrid battery that includes at least one supercapacitor and at least one lead-acid battery. The controller can include a processor with access to a memory. The controller that performs the process 900 can include one or more of the SC adder module 104, the switch and test module 106, the SC controller 116, the controller 110, the memory 114, the base module 108, the database 118, any system(s) that perform any of the processes of any of FIGS. 2-5, the ML engine 820 of FIG. 7, an apparatus, a non-transitory computer-readable storage medium coupled to a processor, component(s) or subsystem(s) of any of these systems, and/or a combination thereof.

At operation 905, the controller is configured to store energy in a hybrid battery, which includes at least one supercapacitor and at least one lead-acid battery. The at least one supercapacitor can include a plurality of supercapacitors. In at least one example, the plurality of supercapacitors can be arranged into a unit to function as a SC battery or a plurality of SC batteries. In at least one example, the system can include an external housing that is operable to house the least one supercapacitor, the at least one lead-acid battery, pair of terminals, and energy controller, such that the size of the external housing is substantially similar to a standard size lead-acid battery for a vehicle and the ends of the pair of terminals are exposed for connection purposes.

At operation 910, the controller is configured to determine if a charge or discharge state is applied to a pair of terminals that are selectively coupled to the at least one supercapacitor and the at least one lead-acid battery.

At operation 915, the controller is configured to determine a charge status of the at least one supercapacitor and the at least one lead-acid battery.

At operation 920, the controller is configured to switch between the at least one supercapacitor and the at least one lead-acid battery based on the determined charge status.

In at least one example, when a charging state is detected, the method is operable to select the at least one supercapacitor and the at least one lead-acid battery based on which of the at least one supercapacitor and the at least one lead-acid battery is below a predetermined charge threshold. For example, the controller can detect if a charge is being supplied to the pair of terminals by a charger and determines which of the at least one supercapacitor or the at least one lead-acid battery to couple to receive the charge based on a which of the at least one supercapacitor or the at least one lead-acid battery is below a predetermined charge threshold. The predetermined charge threshold can one or more of a voltage and/or current capacity of the at least one supercapacitor or the at least one lead-acid battery. The predetermined threshold can also be one of the examples as described herein. In at least one example, the controller can retrieve the predetermined charge threshold for the respective one of the at least one supercapacitor or the at least one lead-acid battery from a database.

When the at least one supercapacitor is being charged, controlling the charging of the at least one supercapacitor to follow a supercapacitor charge profile. In one example, the supercapacitor charge profile can be the same as a lead-acid battery charge profile. In another example, the supercapacitor charge profile can be different from the lead-acid battery charge profile.

In at least one example, once the controller determines which of the at least one supercapacitor or the at least one lead-acid battery to connect to the charger, the controller maintains a connection to the connected one of the at least one supercapacitor or the at least one lead-acid battery until predetermined waiting period has passed. The predetermined waiting period can be the period as described above. In another example, once the controller determines which of the at least one supercapacitor or the at least one lead-acid battery to connect to the charger, the controller maintains a connection to the connected one of the at least one supercapacitor or the at least one lead-acid battery until the predetermined charge threshold is satisfied. The threshold can be one or more of the ones described above. Additionally, the in at least one example, the predetermined charge threshold being satisfied is based on a full charge being reached.

In at least one example, when a discharging state is detected, the method is operable to select the at least one supercapacitor and the at least one lead-acid battery based on which of the at least one supercapacitor and the at least one lead-acid battery is above a predetermined discharge threshold. When the at least one supercapacitor is being discharged, controlling the discharging of the at least one supercapacitor to follow a lead-acid battery discharge profile. This can be done to provide for a consistent and expected discharge status by the hybrid battery. In other examples, different discharge profiles can be performed by the controller of the at least one supercapacitor.

In at least one example, the controller detects if a discharge state is required based on a current draw at the pair of terminals and determines which of the at least one supercapacitor or the at least one lead-acid battery to couple to discharge to a coupled load on the pair of terminals based on a which of the at least one supercapacitor or the at least one lead-acid battery is above a predetermined charge threshold. The controller can be configured to change the discharge profile of the at least one supercapacitor to have a discharge profile that substantially resembles a pattern of discharge for a lead-acid battery profile. The lead-acid battery profile can be stored in a database and the controller is operable to retrieve the lead-acid battery profile. The profile can be one or more of the ones described above. In at least one example, the lead-acid battery profile includes a voltage component and a capacity component, such that the voltage component varies based on the capacity component.

In at least one example, the system can include a switch (as described above) operable to selectively connect, based on instructions from the controller, the at least one supercapacitor or the at least one lead-acid battery to the pair of terminals.

Additionally in one example, the controller is configured to input a charging and discharging profile into a trained machine learning model to identify the charging and discharging profile for the at least one supercapacitor in order that that the supercapacitor has a profile that is like a lead-acid battery. The trained machine learning model can be one or more of those described in regards to FIG. 7.

What is claimed is:

1. A system for charging and/or discharging a hybrid battery that includes a supercapacitor and a lead-acid battery, the system comprising:
at least one supercapacitor;
at least one lead-acid battery;
a pair of terminals operable to be selectively coupled to one of the at least one supercapacitor or at least one lead-acid battery, said pair of terminals operable to provide for discharging and charging of the selectively coupled at least one supercapacitor or at least one lead-acid battery;
a controller that is configured to:
store energy in the at least one supercapacitor and at least one lead-acid battery;
determine if a charge or discharge state is applied to the pair of terminals;
switch between the at least one supercapacitor or at least one lead-acid battery based on the determined charge status.

2. The system of claim 1, wherein the controller detects if a charge is being supplied to the pair of terminals by a charger and determines which of the at least one supercapacitor or the at least one lead-acid battery to couple to receive the charge based on a which of the at least one supercapacitor or the at least one lead-acid battery is below a predetermined charge threshold.

3. The system of claim 2, wherein the predetermined charge threshold is one or more of a voltage and/or current capacity of the at least one supercapacitor or the at least one lead-acid battery.

4. The system of claim 3, wherein the controller retrieves the predetermined charge threshold for the respective one of the at least one supercapacitor or the at least one lead-acid battery from a database.

5. The system of claim 4, wherein once the controller determines which of the at least one supercapacitor or the at least one lead-acid battery to connect to the charger, the controller maintains a connection to the connected one of the at least one supercapacitor or the at least one lead-acid battery until predetermined waiting period has passed.

6. The system of claim 4, wherein once the controller determines which of the at least one supercapacitor or the at least one lead-acid battery to connect to the charger, the controller maintains a connection to the connected one of the at least one supercapacitor or the at least one lead-acid battery until the predetermined charge threshold is satisfied.

7. The system of claim 6, wherein the predetermined charge threshold being satisfied is based on a full charge being reached.

8. The system of claim 1, further comprising an external housing that is operable to house the least one supercapacitor, the at least one lead-acid battery, pair of terminals, and energy controller, such that the size of the external housing is substantially similar to a standard size lead-acid battery for a vehicle and the ends of the pair of terminals are exposed for connection purposes.

9. The system of claim 1, wherein the controller detects if a discharge state is required based on a current draw at the pair of terminals and determines which of the at least one supercapacitor or the at least one lead-acid battery to couple to discharge to a coupled load on the pair of terminals based on a which of the at least one supercapacitor or the at least one lead-acid battery is above a predetermined charge threshold.

10. The system of claim 1, wherein the controller is further configured to change the discharge profile of the at least one supercapacitor to have a discharge profile that substantially resembles a pattern of discharge for a lead-acid battery profile.

11. The system of claim 10, wherein the lead-acid battery profile is stored in a database and the controller is operable to retrieve the lead-acid battery profile.

12. The system of claim 10, wherein the lead-acid battery profile includes a voltage component and a capacity component, such that the voltage component varies based on the capacity component.

13. The system of claim 1, further comprising a switch operable to selectively connect, based on instructions from the controller, the at least one supercapacitor or the at least one lead-acid battery to the pair of terminals.

14. The system of claim 1, wherein the controller is configured to input a charging and discharging profile into a trained machine learning model to identify the charging and discharging profile for the at least one supercapacitor in order that that the supercapacitor has a profile that is like a lead-acid battery.

15. A method for charging and/or discharging a hybrid battery that includes at least one supercapacitor and at least one lead-acid battery, the method comprising:
storing energy in a hybrid battery, which includes at least one supercapacitor and at least one lead-acid battery;
determining if a charge or discharge state is applied to a pair of terminals that are selectively coupled to the at least one supercapacitor and the at least one lead-acid battery;
determining a charge status of the at least one supercapacitor and the at least one lead-acid battery;
switching between the at least one supercapacitor and the at least one lead-acid battery based on the determined charge status.

16. The method of claim 15, wherein when a charging state is detected, the method is operable to select the at least one supercapacitor and the at least one lead-acid battery based on which of the at least one supercapacitor and the at least one lead-acid battery is below a predetermined charge threshold.

17. The method of claim 16, further comprising, when the at least one supercapacitor is being charged, controlling the charging of the at least one supercapacitor to follow a supercapacitor charge profile.

18. The method of claim 15, wherein when a discharging state is detected, the method is operable to select the at least one supercapacitor and the at least one lead-acid battery based on which of the at least one supercapacitor and the at least one lead-acid battery is above a predetermined discharge threshold.

19. The method of claim 18, further comprising, when the at least one supercapacitor is being discharged, controlling the discharging of the at least one supercapacitor to follow a lead-acid battery discharge profile.

20. A non-transitory computer readable storage medium having embodied thereon a program, wherein the program is executable by a processor to perform a method of energy management, the method comprising:
storing energy in a hybrid battery, which includes at least one supercapacitor and at least one lead-acid battery;
determining if a charge or discharge state is applied to a pair of terminals that are selectively coupled to the at least one supercapacitor and the at least one lead-acid battery;
determining a charge status of the at least one supercapacitor and the at least one lead-acid battery;
switching between the at least one supercapacitor and the at least one lead-acid battery based on the determined charge status.
